(19) United States
(12) Patent Application Publication
(10) Pub. No.: US 2014/0064463 A1
(43) Pub. Date: Mar. 6, 2014

(54) VISUAL SELECTION OF CALL PATH THROUGH AN INTERACTIVE VOICE RESPONSE MAP

(71) Applicant: Nagendra Devalla Reddy, Bangalore (IN)

(72) Inventor: Nagendra Devalla Reddy, Bangalore (IN)

(21) Appl. No.: 13/597,635

(22) Filed: Aug. 29, 2012

(51) Int. Cl. H04M 1/64

(52) U.S. Cl. 379/88.01

(57) ABSTRACT

In an example embodiment, a visual map of an Interactive voice response (IVR) system is provided to a client device such as a smartphone. The IVR map includes destinations and/or paths. When a user selects a destination and/or path, a client running on the client device generates the appropriate dual-tone multi-frequency (DTMF) tones for the selected destination and/or path, and sends the DTMF tones to the IVR system.

### TECHNICAL FIELD

The present disclosure relates generally to interactive voice response (IVR).

### BACKGROUND

Interactive voice response (IVR) is a technology that allows a computer to interact with humans through the use of voice commands and/or dual-tone multi-frequency signaling (DTMF) keypad inputs. A caller listens to menu options and responds to prompts to navigate through the system. If a caller knows the path, the caller can input responses without waiting for prompts, however, if a menu option has changed, the caller can get lost.

### BRIEF DESCRIPTION OF THE DRAWINGS

The accompanying drawings incorporated herein and forming a part of the specification illustrate the example embodiments.

FIG. 1 illustrates an example signal diagram for implementing visual selection of a call path through an interactive voice response (IVR) map.

FIG. 2 illustrates examples of IVR maps.

FIG. 3 illustrates an example of a client device that receives an IVR map and generates DTMF tones corresponding to a user selection.

FIG. 4 illustrates an example of a computer system for implementing a client device that receives an IVR map and generates DTMF tones corresponding to a user selection.

FIG. 5 illustrates an example of an apparatus that generates an IVR map for a client device and provides the IVR map to the client device.

FIG. 6 illustrates an example of a computer system that generates an IVR map for a client device and provides the IVR map to the client device.

FIG. 7 illustrates an example of a methodology for a client device that receives an IVR map and generates DTMF tones corresponding to a user selection.

FIG. 8 illustrates an example of a methodology that generates an IVR map for a client device and provides the IVR map to the client device.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus that can receive data representative of an interactive voice response (IVR) map from a participant of a telephone call. The device outputs the IVR map on a user interface and waits for data representative of a user selection. Upon receiving the user selection, the apparatus sends data representative of the selection to the participant. In an example embodiment, dual-tone multi-frequency (DTMF) tones are sent to indicate the selection.

In accordance with an example embodiment, there is disclosed herein, an apparatus that establishes communications with another participant of a telephone call. An IVR map of potential recipients is generated for the participant and transmitted to the participant. Upon receiving data representative of a user selection, a call is placed to the selected recipient.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment, a visual road map from an interactive voice response (IVR) application with applicable destinations is provided to a client device. In particular embodiments, the IVR map comprises multiple permutations and combinations to reach particular destinations. The client device outputs the IVR map, allowing a user to select a destination or path. The client device generates the appropriate DTMF tones for the selection and sends the DTMF tones to the IVR system.

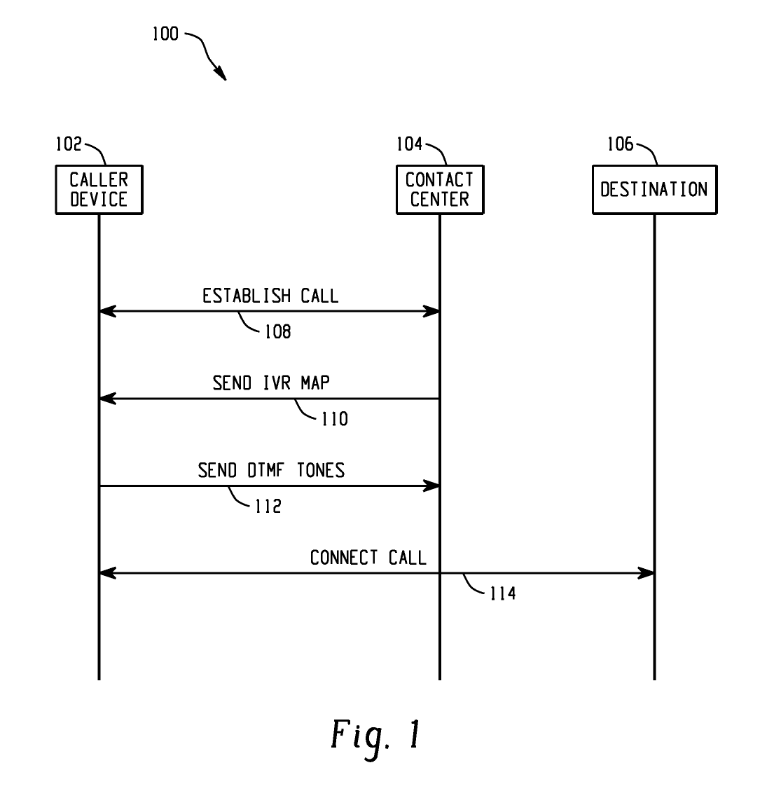

FIG. 1 illustrates an example signal diagram 100 for implementing visual selection of a call path through an interactive voice response (IVR) map. In the illustrated example, a caller using a caller device 102 calls a contact center (or called party) 104. A call between the caller device 102 and the contact center 104 is established as illustrated at 108.

The contact center 104, then sends an IVR Map (or menu tree) to the caller 102 as illustrated by signal 110. In an example embodiment, the contact center 104 receives call information, such as a caller identification and/or group memberships for the caller 102, and dynamically generates a map in accordance with the caller information. For example, an employee calling the office may get a different IVR map than a customer. As another example, an employee working for a first department may receive a different IVR map than an employee working for a second department. As a further example, customers may receive different IVR maps based on their location.

As represented by signal 112, DTMF tone signals are sent from the caller device 102 to the contact center 104 indicating a selection made by a user associated with the caller device 102. In an example embodiment, the DTMF tones are generated by the caller device 102 in response to a selection from the IVR map made by the associated user.

Upon receiving the DTMF tone signals (or other signals comprising data representative of the user selection) from the caller device 102, the contact center attempts to connect the call to the selected destination 106. Signal 114 represents a successful connection.

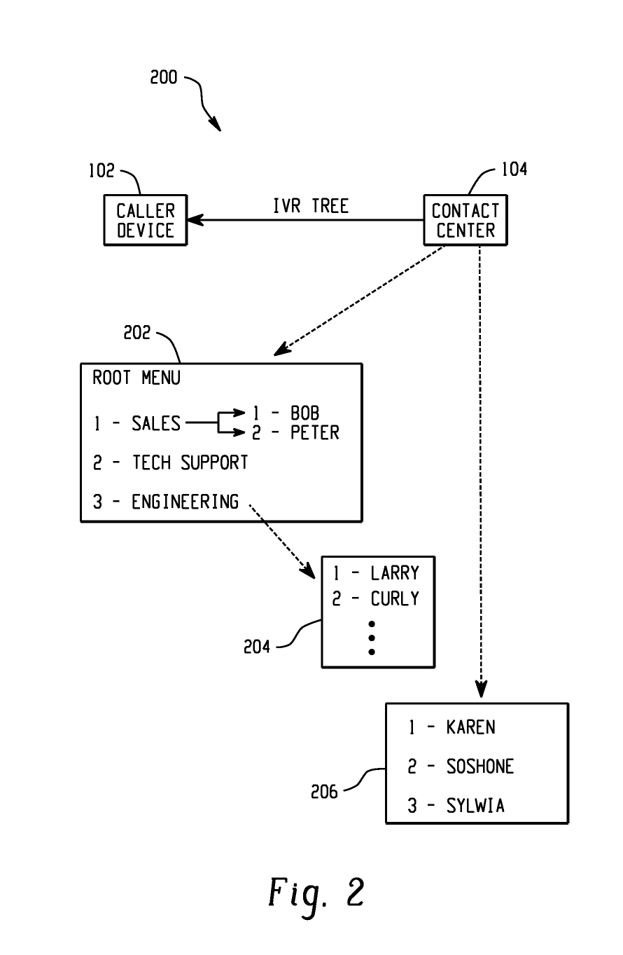

FIG. 2 illustrates examples of IVR maps 200. In the example illustrated in FIG. 2, a first IVR map 202 is generated for a first caller. The first IVR map 202 has three selections, the first selection for sales, which also displays two salesmen, Bob and Peter. The second selection is for technical (tech) support. The third option is for engineering. In the illustrated example, the user can make a selection from the map (e.g., if using a touch screen, touch the desired destination). However, in another example embodiment, the user may type in the number for the selection. For example, if the user does not have a touch screen, the user may type the number next to the selection (e.g., 1-for sales, 11 for Bob in sales, 12 for Peter in sales, 2 for tech support or 3 for engineering).

In the illustrated example, selecting tech support may put the user in a queue that may be answered by the next tech support technician. However, if the user selects engineering, the user may receive a sub menu 204. From the sub menu 204, the user may select an engineer. Note that although the illustrated example shows one sub menu 204, those skilled in the art can readily appreciate that one menu was illustrated for ease of illustration and that the example embodiments described herein may employ multiple sub menus. Moreover, sub menus may be attached to numerous choices.

The illustrated example of IVR maps 200, further includes a second IVR map 206. This IVR map 206 may be generated for a second caller. Note that the IVR map options in menu 202 do not match the options in IVR menu 206, illustrating the dynamic nature of an example embodiment.

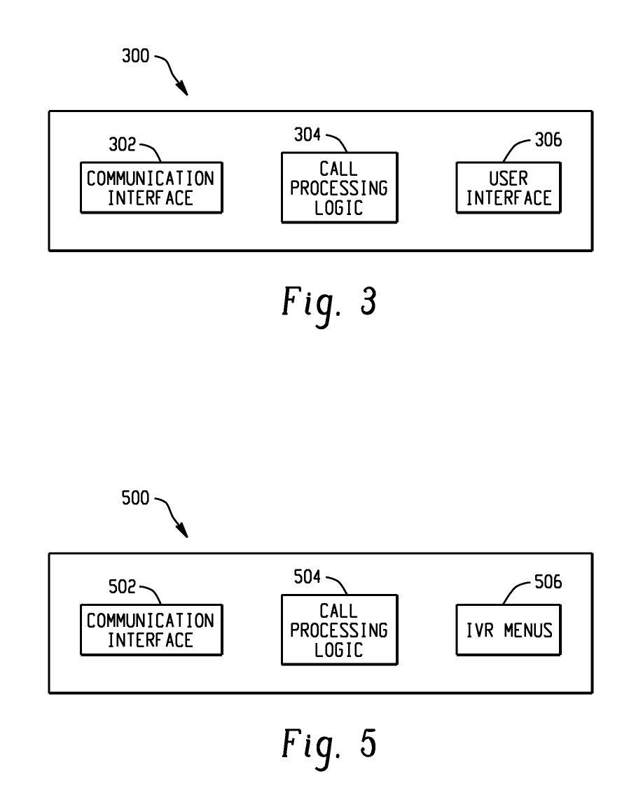

FIG. 3 illustrates an example of a client device 300 that receives an IVR map and generates DTMF tones corresponding to a user selection. The client device 300 comprises a communications interface 302 for establishing communications, such as telephonic communications with a contact center, call processing logic 304, and a user interface 306 for outputting data to a user and for receiving user selections. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

The call processing logic is coupled with the communication interface 302 and can receive IVR maps via communication center 304. In addition, call processing logic 304 is coupled with user interface 306 and can provide IVR map data to user interface 306 to output the IVR map on the user interface. The call processing logic 304 is further operable to receive data representative of a user selection from the IVR map from user interface 306. The call processing logic 304 is operable to transmit data representative of the selection to the contact center via the communication interface 302. In an example embodiment, wherein the call processing logic 304 sends the data representative of the selection in the form of DTMF (dual-tone multi-frequency) tones.

In an example embodiment, the call processing logic 304 is further operable to send caller information to the contact center. This can enable the contact center to send an IVR map tailored to the caller. In particular embodiments, the caller information comprises a user name. In an example embodiment, the caller information comprises a group affiliation.

In an example embodiment, the call processing logic 304 receives a second IVR map in after sending the data representative of a user selection. For example, if the user selected a path directed towards a group of potential recipients, a second IVR map with additional options for the selected path may be received. The call processing logic 304 is further operable to output the second IVR map on the user interface. The call processing logic 304 is operable to receive data representative of a second selection for the call destination from the second IVR map from the user interface 306. The call processing logic 304 is operable to transmit data representative of the second selection to the contact center via the communication interface 302. Additional IVR maps may be received based on the user selection.

In an example embodiment, the user interface 306 comprises a touch screen. This allows the user to select the desired path or destination by touching an area of the touch screen corresponding to the desired path or destination. In an example embodiment, the call processing logic 304 automatically generates DTMF tones corresponding to the user selection. An aspect of this embodiment is that it can aid in preventing user errors caused by pressing the wrong number on a keypad.

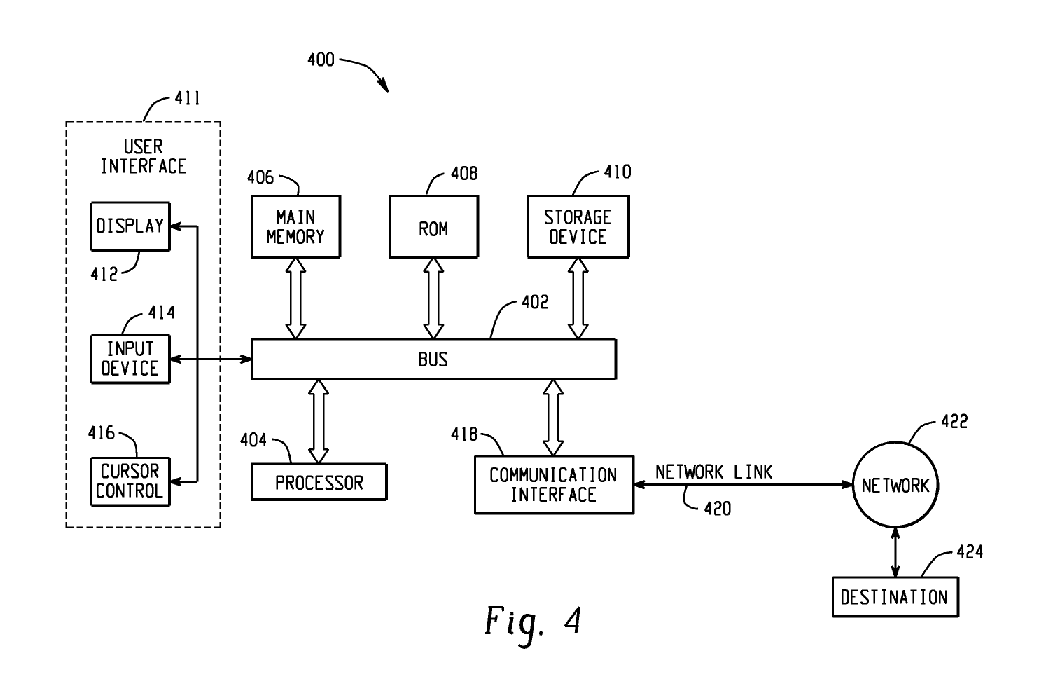

FIG. 4 illustrates an example of a computer system 400 for implementing a client device that receives an IVR map and generates DTMF tones corresponding to a user selection. For example, computer system 400 is suitable for implementing the caller device 102 in FIG. 1 and/or the call processing logic 304 described in FIG. 3.

Computer system 400 includes a bus 402 or other communication mechanism for communicating information and a processor 404 coupled with bus 402 for processing information. Computer system 400 also includes a main memory 406, such as random access memory (RAM) or other dynamic storage device coupled to bus 402 for storing information and instructions to be executed by processor 404. Main memory 406 also may be used for storing a temporary variable or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk, optical disk, and/or flash storage, is provided and coupled to bus 402 for storing information and instructions.

Computer system 400 may be coupled via bus 402 to user interface 411. The user interface 411 may suitably comprise a display 412, such as a cathode ray tube (CRT) or liquid crystal display (LCD), for displaying information to a computer user. The user interface 411 may also comprise an input device 414, such as a keyboard including alphanumeric and other keys coupled to bus 402 for communicating information and command selections to processor 404. Another type of user input device is cursor control 416, such as a mouse, a trackball, cursor direction keys, and/or a touchscreen for communicating direction information and command selections to processor 404 and for controlling cursor movement on display 412. This input device typically has two degrees of freedom in two axes, a first axis (e.g., x) and a second axis (e.g., y) that allows the device to specify positions in a plane.

An aspect of the example embodiment is related to the use of computer system 400 for providing a visual selection of a call path through an IVR map. According to an example embodiment, providing a visual selection of a call path through an IVR map is implemented by computer system 400 in response to processor 404 executing one or more sequences of one or more instructions contained in main memory 406. Such instructions may be read into main memory 406 from another computer-readable medium, such as storage device 410. Execution of the sequence of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 404 for execution. Such a medium may take many forms, including but not limited to non-volatile media, and volatile media. Non-volatile media include, for example, optical or magnetic disks, such as storage device 410. Volatile media include dynamic memory such as main memory 406. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 404 for execution. For example, the instructions may initially be borne on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406 from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling computer system 400 to a network link 420 that is connected to a local network 422. For example, communication interface 418 may be a local area network (LAN) card to provide a data communication connection to a compatible LAN. As another example, communication interface 418 may be an integrated services digital network (ISDN) card or a modem to provide a data communication connection to a corresponding type of telephone line. Wireless links may also be implemented. In any such implementation, communication interface 418 sends and receives electrical, electromagnetic, or optical signals that carry digital data streams representing various types of information.

For example, computer system 400 may receive data representative of an IVR map from destination 424 via network 422, network link 420, and communication link 418. Computer system 400 may send data representative of a user selection (for example DTMF tones) via communication interface 418, network link 420, and network 422 to destination 424.

FIG. 5 illustrates an example of an apparatus 500 that generates an IVR map for a client device (e.g., calling device 102 in FIG. 1) and provides the IVR map to the client device. The apparatus 500 comprises a communication interface 502 for establishing communications with external devices, and call processing logic 504 communicatively coupled with the communication interface. The apparatus further comprises logic for providing IVR menus 506. The logic for providing IVR menus 506 may employ preconfigured IVR menus, or the IVR menus may be dynamically generated.

The call processing logic 504 is operable to receive a call from a caller via the communication interface 502. The call processing logic 504 is operable to automatically generate an interactive voice response (IVR) map for the call. The IVR map may be generated from an existing IVR maps or dynamically generated for the call. The call processing logic 504 is operable to send data representative of the IVR map to the caller via the communication interface. The call processing logic 504 is operable to receive data representative of a selection from the IVR map (such as DTMF tones) from the caller via the communication interface 502. The call processing logic 504 is operable to route the call to a destination corresponding to the selection.

In an example embodiment, the call processing logic 504 receives data representative of the caller. This can enable the call processing logic 504 to dynamically generate an IVR map based on the data representative of the caller. For example, the data representative of a caller comprises data representative of a caller identification. If the caller identification is recognized, the call processing logic 504 may provide a personalized IVR map for the caller; otherwise, the caller processing logic 504 may provide a default IVR tree. In particular embodiments, the data representative of a caller comprises data representative of a group affiliation. This can enable the call processing logic 504 to provide a customized IVR menu for a particular group of callers.

In an example embodiment, the call processing logic 504 is responsive to receiving the data representative of a selection from the IVR map from the caller via the communication interface to generate a second IVR map corresponding to the data representative of the selection from the first IVR map. For example, if the selection was for a particular department, a second IVR map may be sent with members of the department. In particular embodiments, the menu may provide a visual cue of members of the department who are presently not able to answer a call. For example, members of the department who are busy with another call and/or absent. The call processing logic 504 is operable to send data representative of the second IVR map to the caller via the communication interface 502. The call processing logic 504 is operable to receive data representative of a second selection from the second IVR map from the caller via the communication interface 502 and route the call to the destination corresponding to the second selection (or provide yet another IVR menu if applicable).

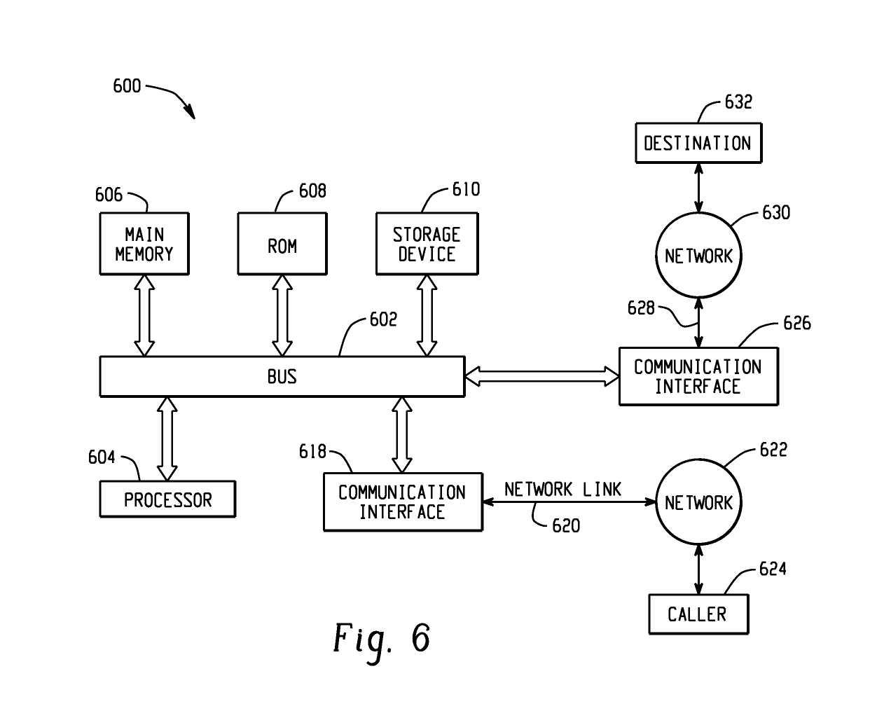

FIG. 6 illustrates an example of a computer system 600 that generates an IVR map for a client device and provides the IVR map to the client device. For example, computer system 600 may be employed to implement contact center 104 (FIG. 1) and/or apparatus 500 in FIG. 5.

Computer system 600 includes a bus 602 or other communication mechanism for communicating information and a processor 604 coupled with bus 602 for processing information. Computer system 600 also includes a main memory 606, such as random access memory (RAM) or other dynamic storage device coupled to bus 602 for storing information and instructions to be executed by processor 604. Main memory 606 also may be used for storing a temporary variable or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk, optical disk, and/or flash storage, is provided and coupled to bus 602 for storing information and instructions.

An aspect of the example embodiment is related to the use of computer system 600 for providing IVR maps and receiving data representative of user selection from an IVR map. According to an example embodiment, providing IVR maps and receiving data representative of a user selection from an IVR map is implemented by computer system 600 in response to processor 604 executing one or more sequences of one or more instructions contained in main memory 606. Such instructions may be read into main memory 606 from another computer-readable medium, such as storage device 610. Execution of the sequence of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement an example embodiment. Thus, embodiments described herein are not limited to any specific combination of hardware circuitry and software.

Computer system 600 also includes a communication interface 618 coupled to bus 602. Communication interface 618 provides a two-way data communication coupling computer system 600 to a network link 620 that is connected to a local network 622. For example, communication interface 618 may be a local area network (LAN) card to provide a data communication connection to a compatible LAN. As another example, communication interface 618 may be an integrated services digital network (ISDN) card or a modem to provide a data communication connection to a corresponding type of telephone line. Wireless links may also be implemented. In any such implementation, communication interface 618 sends and receives electrical, electromagnetic, or optical signals that carry digital data streams representing various types of information.

In an example embodiment, computer system 600 also includes a second communication interface 626 coupled to bus 602. The second communication interface 626 provides a two-way data communication coupling computer system 600 to a network link 628 that is connected to a network 630. For example, communication interface 626 may be a local area network (LAN) card to provide a data communication connection to a compatible LAN. As another example, communication interface 626 may be an integrated services digital network (ISDN) card or a modem to provide a data communication connection to a corresponding type of telephone line. Wireless links may also be implemented. In any such implementation, communication interface 618 sends and receives electrical, electromagnetic, or optical signals that carry digital data streams representing various types of information.

Computer system 600 receives a call from caller 624 via network 622 and network link 620. Computer system 600 provides caller 624 with a IVR menu and waits for a response. In an example embodiment, the response is received in the form of DTMF signal tones that represent a selection. Computer system 600 then facilitates the establishment of a call between caller 624 and a selected destination, which is destination 632 in this example. For purposes of illustrating an example embodiment, caller 624 and destination 632 are located on different networks, networks 622 and 630 respectively; however, those skilled in the art should readily appreciate that in particular embodiments, the caller 624 and destination 632 may be coupled with the same network.

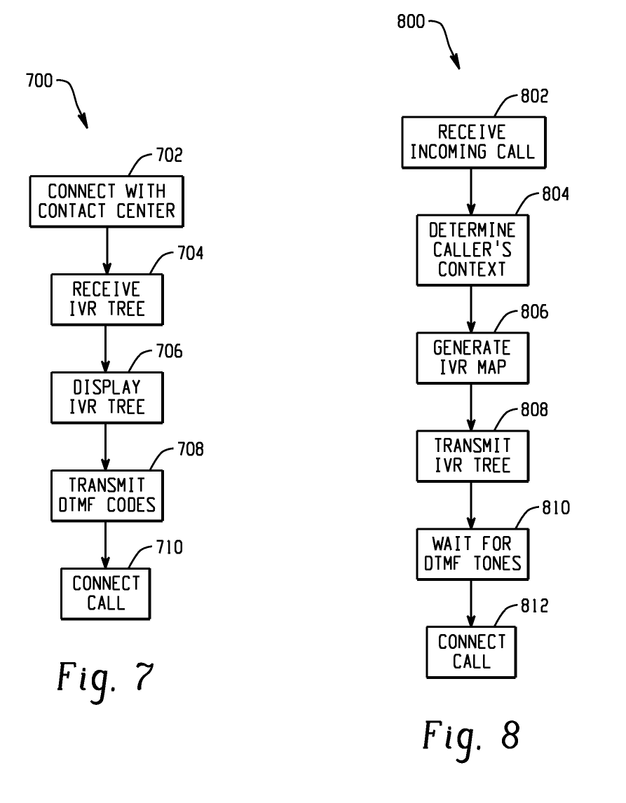

In view of the foregoing structural and functional features described above, methodologies in accordance with example embodiments will be better appreciated with reference to FIGS. 7 and 8. While, for purposes of simplicity of explanation, the methodologies of FIGS. 7 and 8 are shown and described as executing serially, it is to be understood and appreciated that the example embodiments described herein are not limited by the illustrated orders, as some aspects could occur in different orders and/or concurrently with other aspects from that shown and described herein. Moreover, not all illustrated features may be required to implement these methodologies in accordance with an aspect of an example embodiment. The methodologies described herein are suitably adapted to be implemented in hardware, software, or a combination thereof.

FIG. 7 illustrates an example of a methodology 700 for a client device that receives an IVR map and generates DTMF tones corresponding to a user selection. Methodology 700 may be implemented by call processing logic 304 in FIG. 3 and/or computer system 400 in FIG. 4

At 702, a connection is established with a contact center. For example, a caller may establish a telephonic connection with the contact center.

At 704, an IVR map is received from the contact center. The IVR map comprises call paths and/or destinations.

At 706, the IVR map is output. In an example embodiment, the IVR map is displayed on a display device such as a monitor or a touch screen.

At 708, data representative of a selection is received. For example, the data may be in the form of a number received from a keypad or from an area of a touch screen.

At 710, data representative of the selection is transmitted to the contact center. For example, DTMF signal tones corresponding to the number of the selection are automatically generated and transmitted to the contact center.

At 712, the call is connected. The user is able to complete the call without listening to audio signals. Moreover, since the IVR menu is visually displayed, if the user is distracted, the IVR menu will remain on the display and the user does not have to request that the IVR system repeat the menu choices.

FIG. 8 illustrates an example of a methodology 800 that generates an IVR map for a client device and provides the IVR map to the client device. Methodology 800 may be implemented by call processing logic 504 in FIG. 5 and/or computer system 600 in FIG. 6.

At 802, an incoming call is received. The incoming call may be received at a telephone contact center with IVR capabilities.

At 804, the caller's context is determined. The caller's context may include whether the caller is a visitor or a party known to the system, caller identification, user identification and/or group affiliations.

At 806, an IVR map is generated. The IVR map may be obtained from an existing IVR map, however, in another example embodiment, the IVR map may be dynamically created based on the caller's context. For example, a default IVR map may be provided to a visitor or unknown caller whereas an employee or contractor may be provided with a dynamically generated IVR map. In particular embodiments, users of the IVR system may set personal settings for their IVR map, e.g., certain endpoints may be located at the beginning of the list and/or other endpoints may be removed from the map and not displayed.

At 808, the data representative of the IVR map is transmitted to the user. The IVR map may be transmitted as textual, graphical, or a combination of textual and graphical data.

At 810, the IVR system waits for a response. In particular embodiments, DTMF tone signals are employed to indicate the selection from the IVR map.

At 812, the call is connected based on the selection from the IVR map.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
a communication interface for communicating with a contact center;
a user interface;
call processing logic communicatively coupled with the communication interface and the user interface;
the call processing logic operable to receive data representative of an interactive voice response (IVR) map from the contact center;
the call processing logic is further operable to output the IVR map on the user interface;
the call processing logic is operable to receive data representative of a selection of a call destination from the IVR map from the user interface; and
the processing logic is operable to transmit data representative of the selection to the contact center via the communication interface.

2. The apparatus set forth in claim 1, wherein the call processing logic sends dual-tone multi-frequency tones for the data representative of the selection.

3. The apparatus set forth in claim 1, wherein the call processing logic is further operable to send caller information to the contact center.

4. The apparatus set forth in claim 3, wherein the caller information comprises a user name.

5. The apparatus set forth in claim 3, wherein the caller information comprises a group affiliation.

6. The apparatus set forth in claim 1, wherein the call processing logic receives a second IVR map in after sending the data representative of a user selection;
the call processing logic is further operable to output the second IVR map on the user interface;
the call processing logic is operable to receive data representative of a second selection for the call destination from the second IVR map from the user interface; and
the call processing logic is operable to transmit data representative of the second selection to the contact center via the communication interface.

7. The apparatus set forth in claim 1, wherein the user interface comprises a touch screen.

8. Logic encoded in a non-transitory tangible computer readable medium for execution by a processor, and when executed operable to:
receive data representative of an interactive voice response (IVR) map from the contact center;
output the IVR map;
receive data representative of a selection of a call destination from the IVR menu; and
transmit data representative of the selection to the contact center via the communication interface.

9. The logic according to claim 8, wherein dual-tone multi-frequency signaling tones are employed for sending the data representative of the selection.

10. The logic according to claim 8, further operable to:
receive a second IVR map in after sending the data representative of a user selection;
output the second IVR map;
receive data representative of a second selection for the call destination from the second IVR map from the user interface; and
transmit data representative of the second selection.

11. A method, comprising:
receiving data representative of an interactive voice response (IVR) map from the contact center;
outputting the IVR map;
receiving data representative of a selection of a call destination from the IVR menu;
determining by a processor, dual-tone multi-frequency tones corresponding to the selection of the call destination; and
sending the dual-tone multi-frequency tones.

12. An apparatus, comprising:
a communication interface;
call processing logic communicatively coupled with the communication interface;
the call processing logic is operable to receive a call from a caller via the communication interface;
the call processing logic is operable to automatically generate an interactive voice response (IVR) map for the call;
the call processing logic is operable to send data representative of the IVR map to the caller via the communication interface;
the call processing logic is operable to receive data representative of a selection from the IVR map from the caller via the communication interface; and
the call processing logic is operable to route the call to a destination corresponding to the selection.

13. The apparatus set forth in claim 12, wherein the call processing logic receives data representative of the caller; and
the call processing logic is further operable to dynamically generate an IVR map based on the data representative of the caller.

14. The apparatus set forth in claim 13, wherein the data representative of a caller comprises data representative of a caller identification.

15. The apparatus set forth in claim 13, wherein the data representative of a caller comprises data representative of a group affiliation.

16. The apparatus set forth in claim 12, wherein the call processing logic is responsive to receiving the data representative of a selection from the IVR map from the caller via the communication interface to generate a second IVR map corresponding to the data representative of the selection from the first IVR map;
the call processing logic is operable to send data representative of the second IVR map to the caller via the communication interface;
the call processing logic is operable to receive data representative of a second selection from the second IVR map from the caller via the communication interface; and
the call processing logic routes the call to the destination corresponding to the second selection.

17. Logic encoded in a non-transitory tangible computer readable medium for execution by a processor, and when executed operable to:
receive a call from a caller;
automatically generate an interactive voice response (IVR) map for the call from an existing IVR map;
send data representative of the IVR map to the caller via a communication interface;
receive data representative of a selection from the IVR map from the caller via the communication interface; and
route the call to a destination corresponding to the selection.

18. The logic according to claim 17, wherein dual-tone multi-frequency tones are received to represent the selection from the IVR menu.

19. The logic according to claim 17, wherein the logic receives data representative of the caller; and
the logic is further operable to dynamically generate an IVR map based on the data representative of the caller.

20. The logic according to claim 17, the logic is further operable to:
generate a second IVR map corresponding to the data representative of the selection from the first IVR map;
send data representative of the second IVR map to the caller; and
receive data representative of a second selection from the second IVR map;
wherein the call processing logic routes the call to the destination corresponding to the second selection.

21. A method, comprising:
receiving a call from a caller via a communication interface;
automatically generating, by a processor, an interactive voice response (IVR) map from an existing IVR map for the call;
sending data representative of the IVR map to the caller via the communication interface;
receiving data representative of a selection from the IVR map from the caller via the communication interface; and
routing the call to a destination corresponding to the selection.

22. The method according to claim 21, wherein receiving data representative of a selection comprises receiving dual-tone multi-frequency tones that represent the selection from the IVR menu.

23. The method according to claim 21, further comprising:
receiving data identifying the caller; and
wherein the IVR map is dynamically generated based on the data identifying the caller.

24. The method according to claim 21, further comprising:
generating a second IVR map in response to receiving data representative of a selection from the IVR map, the second IVR map based on the data representative of the selection from the first IVR map;
sending data representative of the second IVR map to the caller; and
receiving data representative of a second selection from the second IVR map;
wherein the call is routed to the destination corresponding to the second selection.
